(19) United States
(12) Patent Application Publication
(10) Pub. No.: US 2002/0145411 A1
(43) Pub. Date: Oct. 10, 2002

(54) Current source able to operate at low supply voltage and with quasi-null current variation in relation to the supply voltage

(75) Inventor: Philippe Sirito-Olivier, Par Martigues (FR)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics S.A., Montrouge (FR)

(21) Appl. No.: 10/082,785

(22) Filed: Feb. 25, 2002

(30) Foreign Application Priority Data
Feb. 26, 2001 (FR) 0102579

(51) Int. Cl. G05F 3/16

(52) U.S. Cl. 323/315

(57) ABSTRACT

A current source includes a current mirror and a core connected together between two supply terminals. The current mirror comprises a pilot transistor and first and second recopy transistors. The core comprises first and second transistors and a resistance. The first transistor and the first recopy transistor are connected together to form a first branch. The resistance and the second recopy transistor are connected together to form a second branch. The pilot transistor and the second transistor are connected together to form a third branch. These branches are connected between the two supply terminals. The first transistor is linked to the second branch between the resistance and the second recopy transistor. The second transistor is connected to the first branch between the first core transistor and the first recopy transistor.

### FIELD OF THE INVENTION

The present invention relates to current sources, and more particularly, to a current source that operates at a low supply voltage and with quasi-null current variation in relation to a supply voltage.

### BACKGROUND OF THE INVENTION

Current sources that operate at a low supply voltage and with quasi-null current variation in relation to a supply voltage are used, in particular, for polarizing circuits such as operational amplifiers, for example. These circuits are intended to operate over wide voltage ranges.

For example, one can consider portable devices that may be supplied either from a battery or from a main power supply. These devices can be radio devices, and devices for reading or sound reproduction. When these devices operate on a battery, the supply voltage is relatively low, on the order of 3 volts for example, and diminishes when the battery drains down to about 2 volts or less. When these devices operate from a main power supply, the supply voltage is on the order of 5 volts. There can be a ratio of 2 or even 3 between the two supply voltages.

At present the current sources used in this type of application are such as that shown in FIG. 1. This source of current, produced in this example using bipolar technology, is connected between two supply terminals. Terminal 20 is connected to a high potential V_{CC} and the other terminal 21 is connected to a low potential Vₑₑ, which is generally ground.

The current source comprises a core C and a current mirror M mounted in series between the two supply terminals 20, 21. The core C is the part of the current source which controls an equation corresponding to the source current. In this case, it concerns a so-called V_{BE}/R source. The core C comprises a transistor Q1, a resistance R for setting the current and possibly an additional transistor Q2. The core C is connected to one of the supply terminals 21, in this case the terminal 21 at the potential Vₑₑ. The transistors Q1 and Q2 of the core are of the same type, in this case of the n-p-n type in this case.

In the description below, a voltage V_{BE} represents a base-emitter voltage and a voltage V_{CE} represents a collector-emitter voltage. The current mirror M comprises a pilot transistor Q5 and at least one recopy transistor Q4. The mirror M is linked to the other supply terminal 20, in this example, the potential V_{CC}. The mirror transistors Q4, Q5 are of the same type, in this case of the p-n-p type, and are complementary to those of the core C. They are produced at the same time and are thus identical.

The transistor Q1 is connected between the supply terminal 21 and the recopy transistor Q4 of the mirror M. These two transistors Q1, Q4 form a slave branch 22 between the two supply terminals 20, 21. The base of the transistor Q1 is connected to a first end of the resistance R for current setting. The second end of the resistance R is connected to the supply terminal 21 at the potential Vₑₑ. The first end of the resistance R is also connected to the pilot transistor Q5 of the mirror M via the additional transistor Q2. The resistance R for setting the current, the additional transistor Q2 and the pilot transistor Q5 form a pilot branch 23 between the two supply terminals 20, 21. The transistor Q1 is configured as a diode, that is, its base is connected to its collector via the additional transistor Q2. The mirror M is connected to the other supply terminal 20, in this case at the potential V_{CC}.

The recopy transistor Q4 of the mirror M has its emitter connected to the supply terminal 20 at the potential V_{CC}, its collector connected to the transistor O1 of the core C and its base connected to the base of the pilot transistor Q5 of the mirror M. The pilot transistor Q5 of the mirror M has its base connected to the base of the recopy transistor Q4 of the mirror M and to its collector. It is configured as a diode. Its connector is also linked to the resistance R of the core C via the additional transistor Q2. The emitter of the pilot transistor Q5 is connected to the supply terminal 20 at the potential V_{CC}.

The polarization current of the source is accessible at the level of the collector of an output transistor Q6, which is configured as recopy transistor relative to the mirror M. Its emitter is connected to the supply terminal 20 at the potential V_{CC}, and its base to the base of the pilot transistor Q5 of the mirror M. The output transistor Q6 is identical to the pilot transistor Q5. This polarization source is described on page 324 of the work “Analysis and Design of Analog Integrated Circuits” by P R GRAY and R. G. MEYER, 3rd Edition.

One can assume that in the core C, the current I crossing the resistance R, and which corresponds to the collector current of the transistor Q2, is the same as that circulating in the branch 22 by current mirror effect. Thus, one has:

I=(V_{T}/R×1n(I/I_{S})

where the thermal voltage V_{T} equals kT/q, k is Boltzmann constant, T the temperature in degrees Kelvin and q the charge of the electron. I_{S} represents the saturation current of the transistor Q2.

If I is known, this makes it possible to determine the expression of the polarization current Ic(Q6) of the source at the level of the output transistor Q6:

Ic(Q6)=I×(1+V_{CE}(Q6)/V_{EA}(Q6)/1+V_{CE}(Q5)/V_{EA}(Q5))

where V_{EA}(Q6) and V_{EA}(Q5) are respectively the Early voltages of the transistors Q6 and Q5. They are equal, since the transistors Q6 and Q5 are of the same p-n-p type and are identical. The voltage V_{CE}(Q5) is equal to V_{BE}(Q5) because the pilot transistor Q5 is configured as a diode. The voltage V_{BE}(Q5) remains relatively constant while V_{CC} varies.

The current Ic(Q6) varies in the same direction as the potential difference between the two supply terminals 20, 21 since V_{CE}(Q6) varies in the same direction as this potential difference. In the rest of the description below, this potential difference is assimilated to V_{CC} since it has already been assumed that the supply terminal 21 is at a ground potential.

To obtain a polarization current in the opposite direction from the current Ic(Q6), that is, complementary to the current Ic(Q6), one can add a second output transistor Q3 configured as a current mirror with the Q1 transistor of the core. In this second mirror, the transistor Q1 is the pilot transistor and the transistor Q3 is a recopy transistor.

This recopy transistor Q3 has its base connected to the base of the transistor Q1, its emitter connected to the first supply terminal 21 at the potential Vₑₑ and its collector forms another source output. The collector current of the transistor Q3 is given by:

Ic(Q3)=I×(1+V_{CE}(Q3)/V_{EA}(Q3))/1+V_{CE}(Q1)/V_{EA}(Q1))

Ic(Q3)=I×(1+V_{CE}(Q3)/V_{EA}(Q3))/1+V_{BE}(Q1)+V_{BE}(Q2))/V_{EA}(Q1))

V_{EA}(Q3) and V_{EA}(Q1) are Early voltages of the Q3 and Q1 transistors respectively. They are equal and correspond to the Early voltages of n-p-n transistors since Q1 and Q3 are identical n-p-n transistors. In this case again V_{BE}(QL) and V_{BE}(Q2) remain relatively constant while V_{CC} varies, but V_{CE}(Q3) varies in the same direction as V_{CC}, and thus I_{C}(Q3) varies in the same direction as V_{CC}.

The properties of electronic circuits polarized by a current source are intrinsically linked with the current consumption of their components. For example, the gain of a transistor increases as the current passing therethrough increases. To have properties as constant as possible to control electronic circuits, the polarization current should be as constant as possible regardless of the value of the supply voltage.

The polarization current source of FIG. 1 is not completely satisfactory from this point of view. In addition, this polarization current source only starts up when the supply voltage Vcc reaches a relatively high value. This property is disadvantageous when the supply voltage is provided by a battery which is somewhat discharged, since there is the risk that the polarization current may not start up.

The minimum supply voltage for starting up the current source is given by:

V_{CCmin}=V_{BE}(Q1)+V_{BE}(Q2)+V_{CEsat}(Q4)

that is, 2V_{BE}+V_{CEsat}. This equation applies to branch 22. For branch 23:

V_{CCmin}=RI+V_{CEsat}(Q2)+V_{BE}(Q5)

V_{CCmin}=V_{BE}(Q1)+V_{CEsat}(Q2)+V_{BE}(Q5)

that is, V_{CCmin}=2V_{BE}+V_{CEsat}. This voltage V_{CCmin} is on the order of 1.7 volts with bipolar transistors.

### SUMMARY OF THE INVENTION

In view of the foregoing background, an object of the present invention is to overcome the disadvantages presented by the current source illustrated in FIG. 1.

The present invention relates to a current source whose current is almost constant while the supply voltage varies and which, in addition, can start up at a low supply voltage.

More precisely, the present invention relates to a source of current set between two supply terminals. The current source comprises a current mirror and a core connected together. These items are discrete. The current mirror and the core form several branches to be connected between the two supply terminals. The mirror comprises a pilot transistor and at least one recopy transistor. The core comprises a first transistor, a second transistor, and a resistance.

The first core transistor and the first recopy transistor are connected together to form the first branch. The resistance and a second recopy transistor of the mirror are linked together to form the second branch. The pilot transistor and the second core transistor are linked together to form the third branch. The first transistor of the core is connected to the second branch between the resistance and the second recopy transistor. The second core transistor is connected to the first branch between the first core transistor and the first recopy transistor.

An output transistor makes the source current accessible. This transistor is a supplementary recopy transistor of the mirror, but is placed off-branch. The mirror transistors are of the same type, and the same applies to the core transistors. In addition, the core transistors and the mirror transistors are complementary.

The mirror transistors may be bipolar. To compensate for the base currents of the mirror transistors, the pilot transistor of the mirror may be configured as a diode through a supplementary transistor. The mirror transistors may be MOS transistors. In the same way, the core transistors may be bipolar transistors or MOS transistors. The supplementary transistor may be either a bipolar or a MOS transistor.

### BRIEF DESCRIPTION OF THE DRAWINGS

Other properties and advantages of the invention will become clear by reading the following description which refers to the attached figures.

FIG. 1 is an electrical diagram of a current source according to the prior art.

FIG. 2 is an electrical diagram of an example of a current source using bipolar transistors according to the present invention.

FIG. 3 is an electrical diagram of another example of a current source using bipolar transistors according to the present invention.

FIG. 4 is an electrical diagram of another example of a current source with the core using MOS transistors and the current mirror using bipolar transistors according to the present invention.

FIG. 5 is an electrical diagram of an example of a current source with the core using bipolar transistors and the current mirror using MOS transistors according to the present invention.

FIG. 6 is a diagram showing the source current of FIG. 1 as a function of the supply voltage V_{CC}.

FIG. 7 is a diagram showing the current of the current source of FIG. 2 as a function of the supply voltage V_{CC}.

### DETAILED DESCRIPTION OF THE PREFERRED EMBODIMENTS

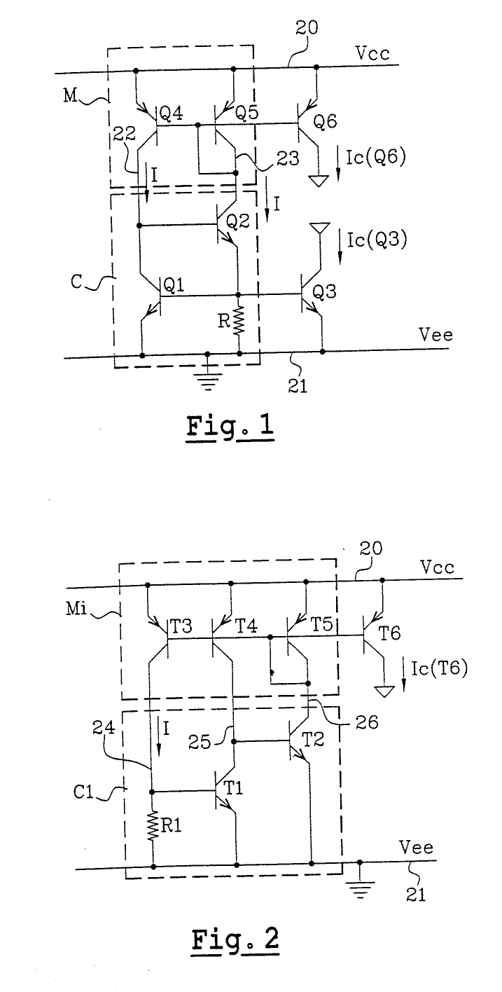

Referring now to FIG. 2, there are two supply terminals 20 and 21 as in FIG. 1. One terminal is at the high potential V_{CC} and the other terminal is at the low potential Vₑₑ, which is generally ground. When referring to the supply voltage, it concerns the potential difference between the potential V_{CC} of the supply terminal 20 and the potential Vₑₑ of the supply terminal 21. In this case, it concerns V_{CC} since it is assumed that the supply terminal 21 is at a ground reference.

The current source comprises several branches 24, 25, 26, with each branch being mounted between the two supply terminals. This current source includes, as in the prior art, a core C1 and a current mirror Mi discrete from the core C1. The mirror Mi and the core C1 are connected together. They will now be described in detail to demonstrate the difference relative to the prior art.

The core C1 is connected to one of the supply terminals 21, in this case the supply terminal at the potential Vₑₑ. The core C1 is formed of a resistance R1 for setting the current and two transistors T1, T2 of the same type. Each of these elements belongs to a different branch.

The current mirror Mi is connected to the other supply terminal 20, in this case the supply terminal 20 at the potential V_{CC}. The current mirror Mi comprises a pilot transistor T5 and two recopy transistors T4 and T3. These three transistors belong to different branches.

The first recopy transistor T4 and the first transistor T1 of the core C1 are connected together to form the first branch 25. The second recopy transistor T3 and the resistance R1 are connected together to form the second branch 24. The pilot transistor T5, which is configured as a diode, and the second transistor T2 of the core C1 are connected together to form the third branch 26.

The first core transistor T1 is connected to the second branch 24 between the resistance R1 and the second recopy transistor T3. The second transistor T2 of the core C1 is connected to the first branch 25 between the first recopy transistor T4 and the first transistor T1 of the core C1.

In the example in FIG. 2, the mirror transistors Mi are of the same type, in this case of the p-n-p type. The transistors of the core C1 are also of the same type, in this case of the n-p-n type. The core transistors are complementary to the mirror transistors.

The connections of the components in FIG. 2 will now be described in more detail. The resistance R1 has one of its ends connected to the supply terminal 21 at the potential Vₑₑ, and its other end connected to the base of the first transistor T1 of the core C1 and to the collector of the second recopy transistor T3 of the mirror Mi. The second recopy transistor T3 has its emitter connected to the supply terminal 20 at the potential V_{CC}, and its base connected to the base of the pilot transistor T5 of the mirror Mi.

The first transistor T1 of the core C1 has its emitter connected to the supply terminal 21 at the potential Vₑₑ, and its collector is connected to the collector of the first recopy transistor T4 of the mirror Mi and to the base of the second transistor T2 of the core C1. The base of the first recopy transistor T4 is connected to the base of the pilot transistor T5, and its emitter is connected to the supply terminal 20 at the potential V_{CC}.

The emitter of the second transistor T2 of the core C1 is connected to the supply terminal 21 at the potential Vₑₑ, and its collector is connected to the collector of the pilot transistor T5. The emitter of the pilot transistor T5 is connected to the supply terminal at the potential V_{CC}, and because it is configured as a diode, base and its collector are connected together.

The mirror Mi comprises, in addition, an output transistor T6 which enables the source current to be accessible. The output transistor T6 is a recopy transistor of the mirror Mi. It is configured as in the conventional current source of FIG. 1. Thus, its base is connected to the base of the pilot transistor T5, its emitter is connected to the supply terminal 20 at the potential V_{CC} and its collector is intended to be connected to a current utilization device which is not shown.

Below are the current equations applicable to this current source. In the core, the current passing through the resistance R1 is of the first order, such that:

I=V_{BE}(T1)/R1

I=V_{T×}ln(I/Is)

Is represents the saturation current for the transistor T1. Taking into account the Early effect, the polarization current of the source, available at the level of the collector of the transistor T6, is such that:

Ic(T6)=I×(1+(V_{CE}(T6)/V_{EA}(T6))/1+(V_{CE}(T5)/V_{EA}(T5))

Ic(T6)=I×(1+(V_{CE}(T6)/V_{EA}(T6))/1+(V_{BE}(T5)/V_{EA}(T5))

When the supply voltage V_{CC} varies, the current I will vary slightly due to the Early effects of the transistors T3 and T4. The transistor T6 will have the same Early effect as the transistor T3 which supplies the current to the resistance R1. Previously, the transistor which supplied the current to the resistance R was the transistor Q5, which was the pilot transistor of the mirror M. Thus one obtains:

Ic(T6)=I×(1+(V_{CE}(T6)/V_{EA}(T6))/1+(V_{CE}(T3)/V_{EA}(T5))

Ic(T6)=I×(1+(V_{CE}(T6)/V_{EA}(T6))/1+((V_{CC}-V_{BE}(T5))

A component (not shown) of the circuit to be supplied is intended to be connected between the collector of the output transistor T6 and the supply terminal 21 at the potential Vₑₑ. The voltage V_{CE}(T6) can then be expressed in the same way as the voltage V_{CE}(T3), that is, in the form of a voltage difference V_{CC} minus the voltage at the terminals of the component (not shown). Consequently, the two differences vary in the same way as a function of V_{CC}, and their ratio becomes almost constant and independent of V_{CC}.

The current Ic(T6) of the current source according to the invention is quasi-constant while the supply voltage varies. As far as the minimum supply voltage V_{CCmin} is concerned, ensuring the start up of the current source for branch 24 it is given by:

V_{CCmin}=V_{BE}(T1)+V_{CEsat}(T3)

For branch 25 one obtains:

V_{CCmin}=V_{BE}(T2)+V_{CEsat}(T4)

For branch 26 one has:

V_{CCmin}=V_{BE}(T5)+V_{CEsat}(T2)

V_{CCmin}=V_{BE}+V_{Cesat}.

This voltage V_{CCmin} is on the order of one volt with bipolar transistors.

Reference is now made to FIGS. 6 and 7. In FIG. 6, with the source of FIG. 1, the current Ic(Q6) varies between −10 microamperes and −12 microamperes, whereas the supply voltage V_{CC} varies between 1.7 volts and 6.5 volts. In FIG. 7, with the source of FIG. 2, the current Ic(T6) remains at about −10 microamperes, whereas the supply current V_{CC} varies between 0.9 volts and 5.5 volts.

The start up is very clear. It corresponds to the straight portion of the graphs and begins at about 1.7 volts on FIG. 6 and about 0.9 volts on FIG. 7. The tests which made it possible to draw up the graphs of FIGS. 6 and 7 also show that the current Ic(Q6) varies by +3.4%/V whereas the current Ic(T6) only varies by +0.03%/V. The Early voltage of the n-p-n transistors was 75 volts, that of the p-n-p transistors was 62 volts, and the current I was about 10 microamperes.

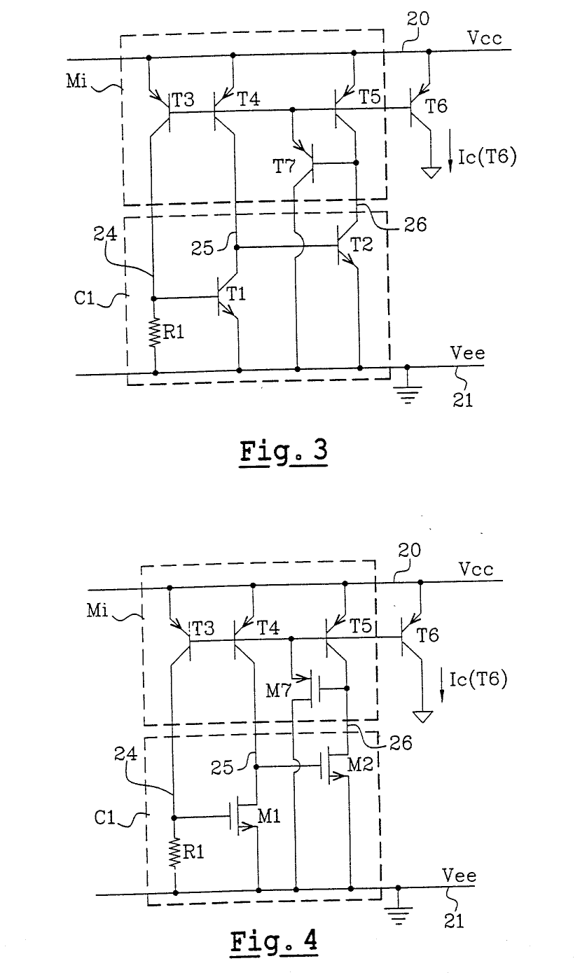

Reference is now made to FIG. 3. If the low start up voltage is no longer a restriction, it is possible to configure the pilot transistor T5 of the mirror Mi as a diode through an additional transistor T7. The additional transistor T7 is a p-n-p transistor like the other transistors of the mirror Mi. Its base is connected to the collector of the pilot transistor T5, its emitter is connected to the base of the pilot transistor T5, and its collector is connected to the supply terminal 21 at the potential Vₑₑ. Instead of using a bipolar transistor of the same type as the mirror transistors T3 to T6, the additional transistor could be a MOS transistor. This variation is shown in FIG. 4.

The transistor T7 compensates the base currents of the transistors of the mirror Mi produced in bipolar technology. In this variation, the minimum supply voltage V_{CCmin} to obtain start up becomes:

V_{CCmin}=V_{BE}(T5)+V_{BE}(T7)+V_{CEsat}(T2)

that is, V_{CCmin}=2V_{BE}+V_{Cesat}.

The configurations described above only contain bipolar transistors. It is possible for the core C1 to be made with MOS transistors as illustrated in FIG. 4. The mirror Mi is identical to that of FIG. 3 with the exception of the additional transistor, which now becomes a MOS transistor referenced as M7. This transistor may also be left out.

The core C1 comprises the resistance R1 and now two MOS transistors M1 and M2. The branches are comparable to those of FIG. 2. The drain of the transistor M1 is connected to the gate of the transistor M2 and to the collector of the transistor T4. The source of the transistor M1 is connected to the supply terminal 21 at the potential Vₑₑ. The gate of the transistor M1 is connected to one of the ends of the resistance R1. The source of the transistor M2 is connected to the supply terminal 21 at the potential Vₑₑ, and the drain of the transistor M2 is connected to the collector of the pilot transistor T5.

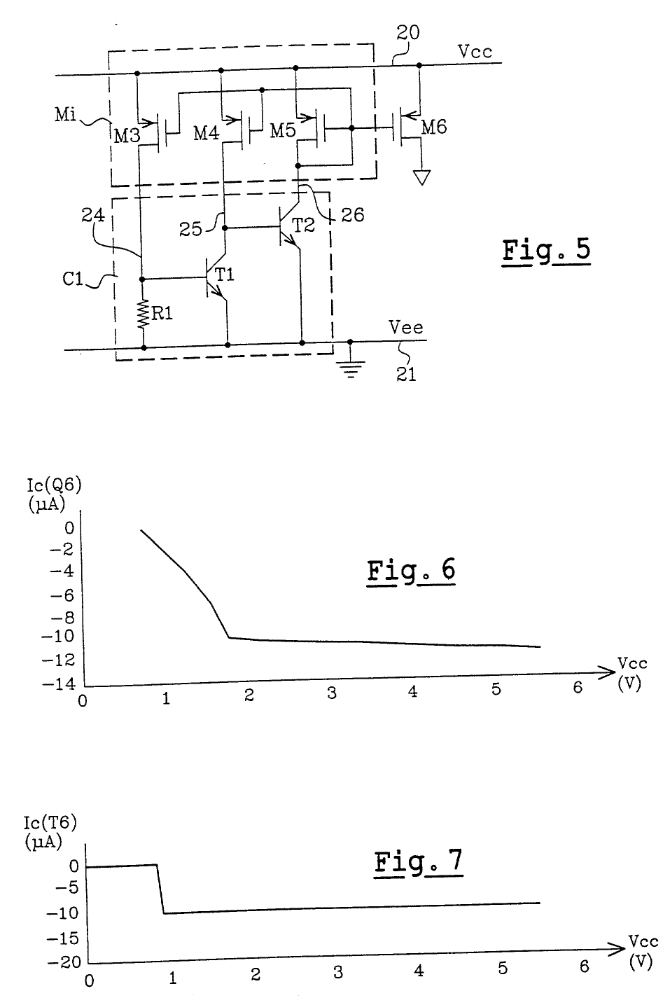

This current source is described as a source in V_{GS}/R instead of being described as a source in V_{BE}/R. Another variation is shown in FIG. 5. Here, the mirror transistors Mi are MOS transistors whereas the core transistors C1 are bipolar as in FIG. 2.

The mirror Mi now comprises a pilot transistor M5, two recopy transistors M4 and M3 and an output transistor M6. The branches are comparable to those of FIG. 2. The second recopy transistor M3 has its source connected to the supply terminal 20 at the potential V_{CC}, its gate connected to the gate of the pilot transistor M5, and its drain connected to the resistance R1 of the core C1.

The gate of the first recopy transistor M4 is connected to the gate of the pilot transistor M5, its source is connected to the supply terminal 20 at the potential V_{CC}, and its drain connected to the collector of the transistor T1 of the core C1. The pilot transistor M5 has its source connected to the supply terminal at the potential V_{CC} and because it is configured as a diode, its gate and its drain are connected together. Its drain is also connected to the collector of the transistor T2 of the core C1.

The output transistor M6 has its gate connected to the gate of the pilot transistor M5, its source connected to the supply terminal 20 at the potential V_{CC}, and its drain is intended to be connected to a utilization device not shown here. It is of course possible for the current source according to the invention to be made entirely in MOS technology by combining the core C1 of FIG. 4 and the mirror Mi of FIG. 5.

All the transistors described above may be replaced by their complements by reversing the supply terminals. The emitters or sources of the transistors which were connected to the supply terminal at the potential Vₑₑ would then be connected to the supply terminal at the potential Vcc and the inverse. As for the resistance R1, instead of being connected to the supply terminal at the potential Vₑₑ it would be connected to the supply terminal at the potential V_{CC}. The direction of the current at the level of the utilization device would thus be reversed.

That which is claimed is:

1. Source of current intended to be set between two supply terminals (20, 21), comprising a current mirror (Mi) and a core (C1) connected together and discrete, this current mirror (Mi) and this core (C1) forming several branches (24, 25, 26) to be connected between the two supply terminals, the mirror (Mi) comprising a pilot transistor (T5) and at least one recopy transistor (T4), the core (C1) comprising a first transistor (T1), a second transistor (T2), and a resistance (R1), characterized in that the first transistor (T1) of the core (C1) and the first recopy transistor (T4) connected together form the first branch (25), the resistance (R1) and a second recopy transistor (T3) of the mirror (Mi) connected together form the second branch (24), the pilot transistor (T5) and the second transistor (T2) of the core connected together form the third branch (26), the first transistor (T1) of the core being linked to the second branch (24) between the resistance (R1) and the second recopy transistor (T3), the second transistor (T2) of the core being linked to the first branch (25) between the first transistor (T1) of the core and the first recopy transistor (T4).

2. Source of current according to claim 1, characterized in that an output transistor (T6) makes the current from the source accessible, this transistor (T6) being a supplementary recopy transistor of the mirror (Mi), this transistor (T6) being off-branch.

3. Source of current according to one or the other of claim 1 or 2, characterized in that the transistors (T3, T4, T5, T6) of the mirror (Mi) are of the same type.

4. Source of current according to any one of claims 1 to 3, characterized in that the transistors (T1, T2) of the core (C1) are of the same type.

5. Source of current according to any one of claims 1 to 4, characterized in that the transistors (T1, T2) of the core (C1) and the transistors (T3, T4, T5, T6) of the mirror (Mi) are complementary.

6. Source of current according to any one of claims 1 to 5, characterized in that the transistors (T3, T4, T5, T6) of the mirror (Mi) are bipolar.

7. Source of current according to claim 6, characterized in that the pilot transistor (T5) of the mirror (Mi) is mounted as a diode through a supplementary transistor (T7).

8. Source of current according to any one of claims 1 to 5, characterized in that the transistors (T3, T4, T5, T6) of the mirror (Mi) are MOS transistors.

9. Source of current according to any one of claims 1 to 8, characterized in that the transistors (T1, T2) of the core (C1) are bipolar.

10. Source of current according to any one of claims 1 to 8, characterized in that the transistors (T1, T2) of the core (C1) are MOS transistors.

11. Source of current according to any one of claims 7 to 10, characterized in that the supplementary transistor (T7) is of the bipolar type.

12. Source of current according to any one of claims 7 to 10, characterized in that the supplementary transistor (M7) is of the MOS type.
